(19) United States
(12) Patent Application Publication
(10) Pub. No.: US 2026/0109070 A1
(43) Pub. Date: Apr. 23, 2026

(54) PRODUCT PALLET FOR STORING THE MACHINING PRODUCTS OF A SEPARATING MACHINING PROCESS OF A PLATE-SHAPED WORKPIECE AND MECHANICAL DEVICE HAVING SUCH A PRODUCT PALLET

(71) Applicant: TRUMPF Werkzeugmaschinen SE + Co. KG, Ditzingen (DE)

(72) Inventor: Clemens Kumpe, Cunewalde (DE)

(21) Appl. No.: 19/359,740

(22) Filed: Oct. 16, 2025

(30) Foreign Application Priority Data
Oct. 21, 2024 (DE) 102024130459.6

(51) Int. Cl. B26D 7/18; B26D 7/00

(52) U.S. Cl. CPC B26D 7/18; B26D 2007/0018

(57) ABSTRACT

A product pallet for storing a workpiece part present as a machining product of a separating machining process of a plate-shaped workpiece, and a scrap skeleton present as a further machining product of the separating workpiece machining process is provided. The product pallet includes support elements formed on a machining product side for common storage of the workpiece part and the scrap skeleton in a direction of gravity. The product pallet is capable of being transferred into a first functional state and to a second functional state. In the first functional state, the workpiece part and the scrap skeleton are capable of being commonly stored in the direction of gravity by the support elements. In the second functional state, the product pallet forms a flat support surface on an upper side thereof, which is configured for storing only the workpiece part in the direction of gravity.

### CROSS REFERENCE TO RELATED APPLICATIONS

This application claims benefit to German Patent Application No. DE 102024130 459.6, filed on October 21, 2024, which is hereby incorporated by reference herein.

### FIELD

Embodiments of the present invention relate to a product pallet for storing a workpiece part present as a machining product of a separating machining process of a plate-shaped workpiece, in particular a metal sheet, and a scrap skeleton present as a further machining product of the separating workpiece machining process, in particular for storing a separable product composite of the workpiece part and the scrap skeleton.

Embodiments of the present invention further relate to a mechanical device for handling a workpiece part present as a machining product of a separating machining process of a plate-shaped workpiece, in particular a metal sheet, and a scrap skeleton present as a further machining product of the separating workpiece machining process, in particular for handling a separable product composite of the workpiece part and the scrap skeleton, wherein the mechanical device has a product pallet of the aforementioned type for storing the workpiece part and the scrap skeleton.

### BACKGROUND

Prior art of the type in question is disclosed in EP 4257285 A1.

In the case of the prior art, a laser cutting machine is used for the separating machining of a metal sheet stored on a pallet. In the process, multiple sheet-metal parts and a scrap skeleton surrounding the sheet-metal parts are created as machining products. Just like the metal sheet during the separating machining process, the machining products are stored on support rails on the pallet immediately after the separating machining process. The support rails are permanently mounted on a frame of the pallet.

The pallet with the machining products is moved from the workspace of the laser cutting machine to an unloading station. At the unloading station, the sheet-metal parts and the scrap skeleton are lifted off the support rails together using a lifting device. For this purpose, upwardly projecting lifting elements are provided on a base plate of the lifting device arranged below the pallet, which move upwards through the intermediate spaces provided between the support rails of the pallet due to a lifting movement of the base plate. In this regard, the lifting elements come to rest with their leading ends on the underside of the machining products stored on the support rails and lift the machining products off the support rails as the lifting movement continues. The scrap skeleton lifted from the pallet support rails is then detected by a gripper and deposited on a scrap skeleton pallet before the sheet-metal parts, which have also been lifted from the pallet support rails, are transferred to a sheet-metal part pallet using a suction frame provided for this purpose.

### SUMMARY

Embodiments of the present invention provide a product pallet for storing a workpiece part present as a machining product of a separating machining process of a plate-shaped workpiece, and a scrap skeleton present as a further machining product of the separating workpiece machining process. The product pallet includes support elements formed on a machining product side for common storage of the workpiece part and the scrap skeleton in a direction of gravity. The product pallet is capable of being transferred into a first functional state and to a second functional state. In the first functional state, the workpiece part and the scrap skeleton are capable of being commonly stored in the direction of gravity by the support elements. In the second functional state, the product pallet forms a flat support surface on an upper side thereof, which is configured for storing only the workpiece part in the direction of gravity.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a product pallet for use in the handling of machining products of a separating sheet-metal machining process in a first functional state according to some embodiments;

FIG. 2 shows the product pallet according to FIG. 1 in a second functional state according to some embodiments;

FIG. 3 shows a sectional view of the product pallet according to FIG. 2 in a sectional plane III indicated in FIG. 2 according to some embodiments;

FIG. 4 shows a separating station of a mechanical device for handling machining products of a separating sheet-metal machining process with the product pallet loaded with the machining products according to FIGS. 1 – FIG. 3 according to some embodiments;

FIG. 5 shows the separating station according to FIG. 4 in the vertical view in the direction of the arrow V in FIG. 4 according to some embodiments; and

FIG. 6, FIG. 7, FIG. 8, FIG. 9 and FIG. 10 show the processes at the separating station according to FIGS. 4 and 5, based on the conditions shown in FIGS. 4 and 5 according to some embodiments.

### DETAILED DESCRIPTION

Embodiments of the present invention provide a mechanical device for handling machining products of a separating machining process of a plate-shaped workpiece in the form of a workpiece part and a scrap skeleton, on which one and the same product pallet can be used both for commonly storing the machining products and for storing the workpiece part separated from the scrap skeleton in a gentle and orderly manner.

According to some embodiments, a product pallet has support elements which are formed on the machining product side for the common storage of the workpiece part and the scrap skeleton in the direction of gravity. The product pallet can be transferred into two functional states.

In a first functional state, the product pallet, like the pallet of the prior art, is designed for commonly storing the machining products of a separating workpiece machining process, in particular a separating sheet-metal machining process. The workpiece and the scrap skeleton of the separating workpiece machining process can be commonly stored on support elements, preferably on conventional support rails, of the product pallet. The product pallet according to embodiments of the invention is in this functional state immediately after the separating workpiece machining process, for example.

After separating the workpiece part from the scrap skeleton, the product pallet according to embodiments of the invention is transferred into a second functional state. In the second functional state of the product pallet, a flat support surface is formed on its upper side, which enables the workpiece part separated from the scrap skeleton to be deposited in a particularly gentle and orderly manner.

According to some embodiments, in a preferred way of implementing the first functional state and the second functional state of the product pallet, the product pallet has an element unit provided with the support elements and a surface unit provided with the support surface. The two units of the product pallet can be moved in a vertical direction relative to one another either into a first relative position or into a second relative position. In the first functional state of the product pallet and in the first relative position of the element unit and the surface unit associated with the first functional state of the product pallet, the support elements project upwards on the machining product side with respect to the support surface. In the second functional state of the product pallet and in the second relative position of the element unit and the surface unit associated with the second functional state of the product pallet, the support elements are arranged flush with the support surface on the machining product side or arranged offset downwards with respect to the support surface.

According to some embodiments, the element unit of the product pallet has a base on which the support elements are provided and project upwards. The base of the element unit is arranged below the support surface of the surface unit. The surface unit is provided with through-openings on the support surface, through which the support elements of the element unit move when the relative position of the element unit and the surface unit changes and the associated change in the functional state of the product pallet occurs.

According to some embodiments, the element unit and the surface unit of the product pallet each form two mutually opposite frame legs of a rectangular pallet frame of the product pallet. Accordingly, the pallet frame of the product pallet according to the invention is composed of two pairs of frame legs which, as parts of the element unit and of the surface unit, can be moved relative to one another in the vertical direction.

In a further embodiment of the product pallet according to the invention, at least one of the pairs of frame legs of the pallet frame is provided with a guide device by means of which the product pallet is guided during movements in the longitudinal direction of the frame legs of the pair of frame legs provided with the guide device. For example, a guide device with guide rollers that interact with associated guide rails when the product pallet is moved can be used as a guide device.

According to some embodiments, each of the two pairs of frame legs of the product pallet according to the invention has a guide device of the above type. The two guide devices enable guided movements of the product pallet in the longitudinal directions of the two pairs of frame legs of the rectangular pallet frame, which extend perpendicular to one another. In this regard, the guide device can be used on the one pair of frame legs in the first relative position of the element unit and the surface unit and thus in the first functional state of the product pallet. The guide device on the other pair of frame legs can be available in the second relative position of the element unit and the surface unit and thus in the second functional state of the product pallet.

Due to their common storage on the support elements of the product pallet in the first functional state, which project upwards with respect to the flat support surface, the machining products are easily accessible for unloading the product pallet. This circumstance is utilized by the unloading unit of the mechanical device.

The mechanical device according to embodiments of the invention has, in addition to an unloading unit, a separating unit and a loading unit. By means of the separating unit, the workpiece part is separated from the scrap skeleton after the workpiece part and the scrap skeleton have been unloaded from the product pallet in the first functional state. The workpiece part separated from the scrap skeleton is then deposited by means of the loading unit on the product pallet, which has previously been transferred from the first functional state into the second functional state and which consequently provides the suitable flat support surface for storing the workpiece part in a gentle and orderly manner.

According to embodiments of the invention, the separating unit is also used, in addition to separating the workpiece part from the scrap skeleton, for unloading the machining products from the product pallet in the first functional state and/or for loading the product pallet in the second functional state with the workpiece part separated from the scrap skeleton.

According to some embodiments, the separating unit forms a compact structural unit which can be used both for unloading the workpiece and the scrap skeleton from the product pallet in the first functional state and for separating the workpiece part from the scrap skeleton and depositing the workpiece part separated from the scrap skeleton on the product pallet transferred into the second functional state.

In a further preferred embodiment of the mechanical device, a lifting device is provided for moving the element unit and the surface unit of the product pallet according to the invention into the first relative position and into the second relative position and thus for transferring the product pallet according to the invention into the first functional state and into the second functional state, by means of which lifting device the element unit and the surface unit of the product pallet can be moved relative to one another in the vertical direction.

According to embodiments of the invention, in which the element unit and the surface unit of the product pallet according to embodiments of the invention can be moved into the first relative position and into the second relative position and thus the product pallet according to the invention can be transferred into the first functional state and into the second functional state using the aforementioned lifting device by means of structurally simple means.

A product pallet 1 shown in the drawings comprises an element unit 2 and a surface unit 3.

The element unit 2 of the product pallet 1 has a base plate 4 as its base, on which support elements of the element unit 2, designed as support rails 5, project upwards. Together with the base plate 4, the element unit 2 is arranged below a support plate 6 of the surface unit 3 of the product pallet 1. The support plate 6 has a support surface 7 on its upper side and is provided with through-openings 8 for the support rails 5 of the element unit 2 on the support surface 7.

A rectangular pallet frame 9 of the product pallet 1 comprises two pairs of frame legs 10, 11, of which the pair of frame legs 10 is part of the element unit 2 and the pair of frame legs 11 is part of the surface unit 3.

Each of the frame legs 12 of the pair of frame legs 10 of the element unit 2 is provided with a guide device in the form of guide rollers 14. The guide rollers 14 guide the product pallet 1 during movements in the longitudinal direction of the frame legs 12 of the element unit 2. Accordingly, concealed guide rollers 15 are provided on the frame legs 13 of the pair of frame legs 11 of the surface unit 3 as a guide device in FIGS. 1 and 2 (FIGS. 5 to 9). By means of the guide rollers 15, the product pallet 1 is guided during movements in the longitudinal direction of the frame legs 13 of the surface unit 3.

The element unit 2 and the surface unit 3 of the product pallet 1 can be moved relative to one another in the vertical direction. This allows the product pallet 1 to be transferred into a first functional state and a second functional state.

In the first functional state shown in FIG. 1 and present at a first relative position of the element unit 2 and the surface unit 3, the product pallet 1 is used to commonly store workpiece parts created during a separating sheet-metal machining process in the form of sheet-metal parts 16 and a scrap skeleton 17 (FIGS. 9, 10) created as a further machining product during the separating sheet-metal machining process in the direction of gravity by means of the support rails 5 projecting upwards with respect to the support surface 7 of the product pallet 1.

In the second functional state shown in FIG. 2 and with an associated second relative position of the element unit 2 and the surface unit 3, the support rails 5 of the element unit 2 do not project upwards with respect to the support plate 6 of the surface unit 2 on the machining product side. Consequently, the product pallet 1 forms the flat support surface 7 on its upper side, which is used in the manner described below for storing only the sheet-metal parts 16 in the direction of gravity.

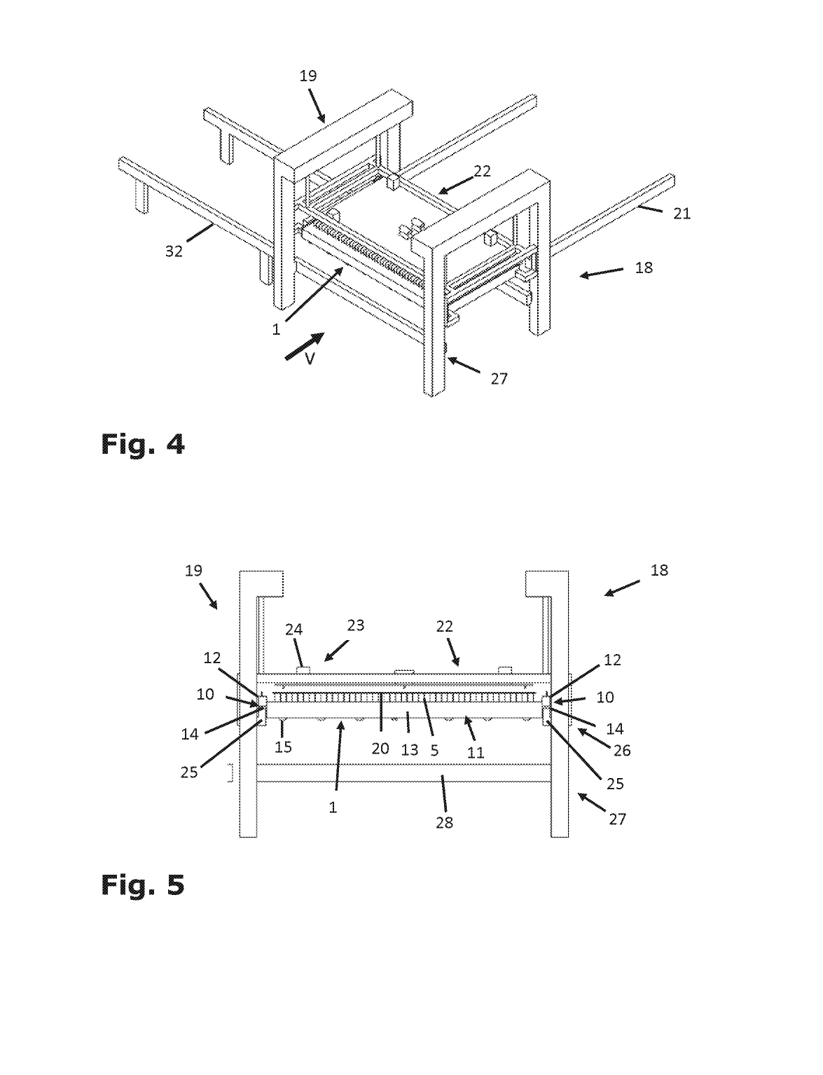

The use of the product pallet 1 as part of a mechanical device 18 for handling the sheet-metal parts 16 and the scrap skeleton 17 is illustrated in FIGS. 4 to 10.

The sheet-metal parts 16 and the scrap skeleton 17 have been created by a separating machining process of a metal sheet on a laser cutting machine not shown. The metal sheet was stored in the workspace of the laser cutting machine during the separating machining process on the product pallet 1. After completion of the separating sheet-metal machining process, the product pallet 1, now loaded with the sheet-metal parts 16 and the scrap skeleton 17, was discharged from the workspace of the laser cutting machine and transferred to a separating station 19 of the mechanical device 18.

FIGS. 4 and 5 show the separating station 19 after the arrival of the product pallet 1 loaded with the sheet-metal parts 16 and the scrap skeleton 17.

During the separating sheet-metal machining process, nanojoints were left between the sheet-metal parts 16 and the scrap skeleton 17. As a result, the sheet-metal parts 16 and the scrap skeleton 17 in FIGS. 4 and 5 form a separable product composite 20.

During the movement into the separating station 19, the product pallet 1 was guided by the guide rollers 14 of the element unit 2 on the guide rails 21, which extend up to the separating station 19.

Since the sheet-metal machining on the laser cutting machine, the product pallet 1 has been in its first functional state. Accordingly, the element unit 2 and the surface unit 3 assume their first relative position in FIGS. 4 and 5.

A separating unit 22 is shown in FIGS. 4 and 5 above the product pallet 1 loaded with the product composite 20.

The separating unit 22 is provided with a holding device 23. The holding device 23 has grippers 24 which, after the product pallet 1 loaded with the product composite 20 has been moved into the separating station 19, are still in their initial position, in which they are arranged outside of the product composite 20 in the vertical projection in the plane of the product composite 20.

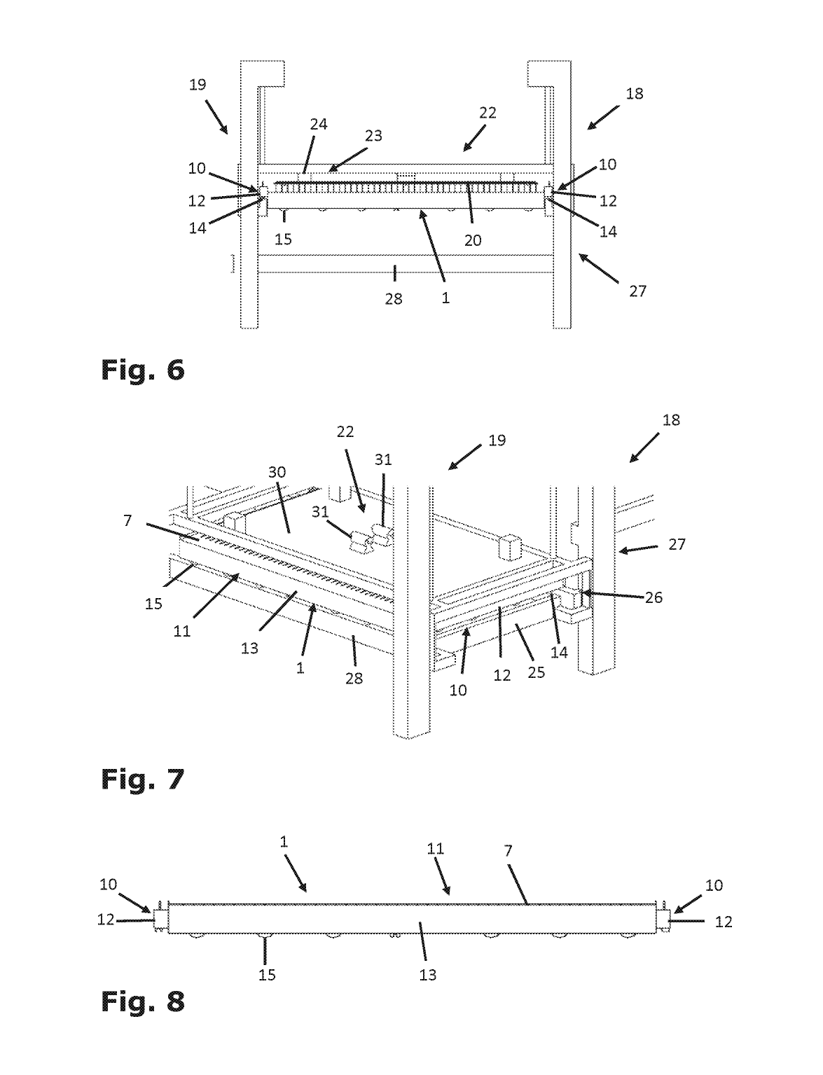

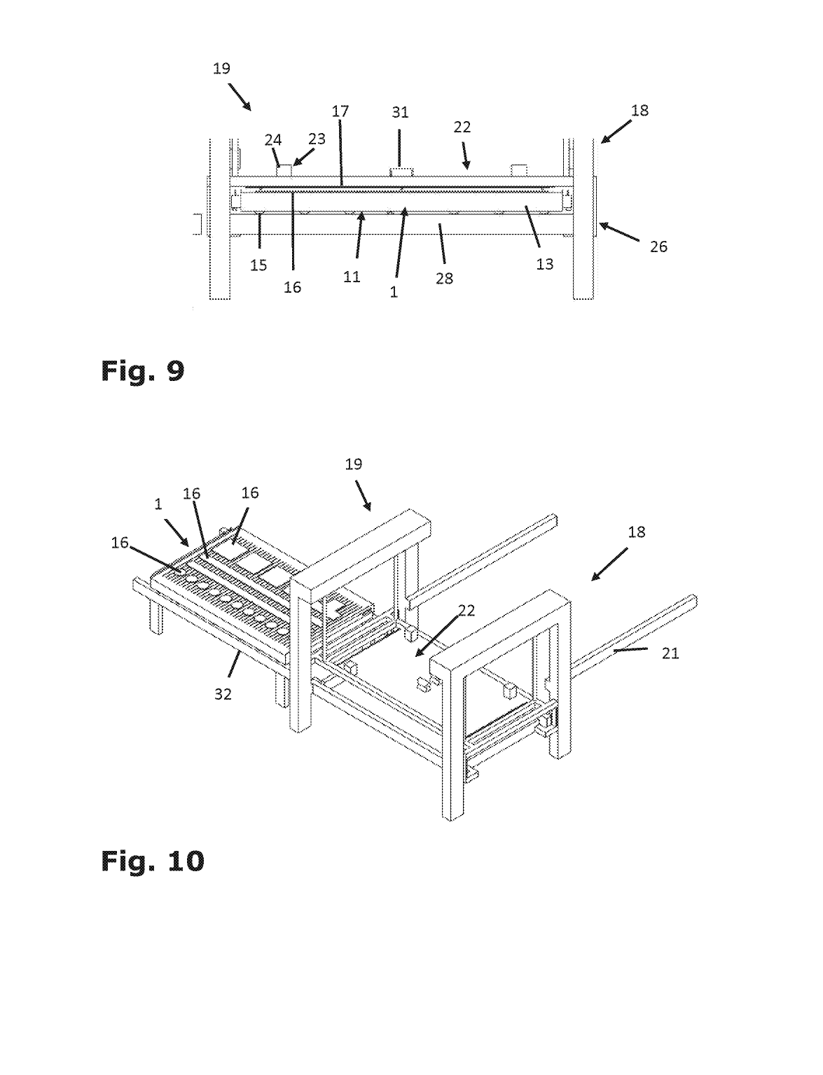

Based on these conditions, the grippers 24 of the holding device 23 are moved into a position in which they grip underneath the product composite 20 on the scrap skeleton 17 (FIG. 6).

In FIGS. 4 to 6, the product pallet 1 with the guide rollers 14 of the pair of frame legs 10 of the element unit 2 is supported in the direction of gravity on horizontal carriers 25 of a lifting device 26 aligned with the guide rails 21. The horizontal carriers 25 of the lifting device 26 can be raised and lowered in a motor-driven manner on a support frame 27 of the separating station 19.

In FIGS. 4 to 6, the surface unit 3 of the product pallet 1 is mounted on the base plate 4 of the element unit 2 in the direction of gravity. In this regard, the frame legs 13 of the surface unit 3 with the guide rollers 15 provided thereon are spaced apart in the vertical direction from a support 28, which is permanently mounted on the support frame 27 of the separating station 19.

Based on the conditions shown in FIG. 6, the product pallet 1 loaded with the product composite 20 and the separating unit 22 are lowered together by means of the lifting device 26.

During the lowering movement, the product pallet 1 comes to rest on the support 28 on the support frame 27 with the guide rollers 15 provided on the frame legs 13 of the surface unit 3.

As the product pallet 1 continues the lowering movement, the element unit 2 of the product pallet 1 moves downwards relative to the surface unit 3, which is now stationary in the direction of gravity. This results in the second relative position of the element unit 2 and the surface unit 3 and, associated with this, the second functional state of the product pallet 1, in which the flat support surface 7 is formed on the upper side of the product pallet 1 (FIGS. 7, 8).

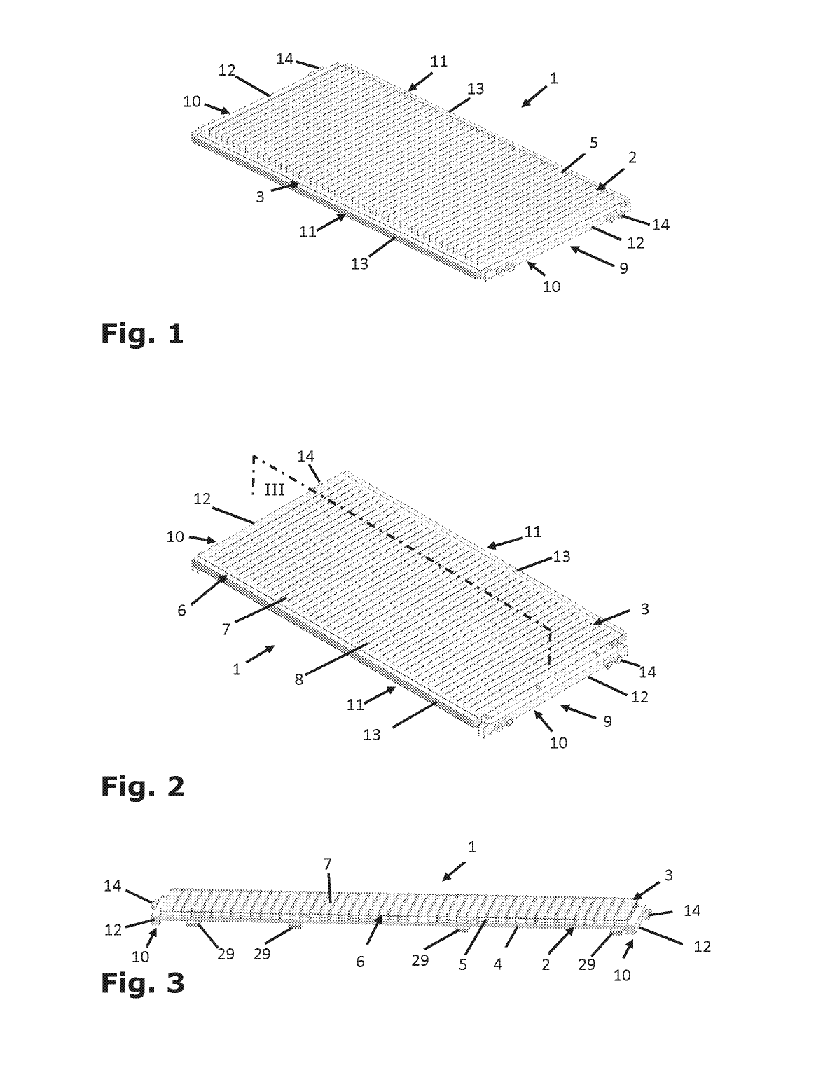

The guide rollers 14 on the frame legs 12 of the element unit 2 now rest at a distance above the horizontal carriers 25 of the lifting device 26. The element unit 2 is mounted with the base plate 4 on stops 29 (FIG. 3) provided for this purpose on the surface unit 3 in the direction of gravity.

If necessary, the first relative position of the element unit 2 and the surface unit 3 could be restored by lifting the element unit 2 relative to the surface unit 3 supported on the support 28.

During the lowering movement of the product pallet 1, the product composite 20 is pulled to the underside of a vibrating plate 30 of the separating unit 22 by means of the holding device 23. Vibrators 31 are arranged on the upper side of the vibrating plate 30 as vibration generators, which cause the vibrating plate 30 to vibrate vertically after the product pallet 1 has been transferred into the second functional state. Due to the vibrations of the vibrating plate 30, the sheet-metal parts 16 are released from the scrap skeleton 17, which is still fixed to the separating unit 22 by means of the holding device 23. Under the effect of gravity, the sheet-metal parts 16 separated from the scrap skeleton 17 are deposited gently and orderly on the flat support surface 7 of the product pallet 1 (FIG. 9).

Guide rails 32 arranged outside of the separating station 19 are aligned with the support 28 on the support frame 27 of the separating station 19. The product pallet 1, which is now only loaded with the sheet-metal parts 16, moves out of the separating station 19 via the guide rails 32. Here, the product pallet 1 is guided on the guide rails 32 by the guide rollers 15 provided on the frame legs 13 of the surface unit 3.

The scrap skeleton 17 fixed to the separating unit 22 is removed separately from the separating station 19.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A product pallet for storing a workpiece part present as a machining product of a separating machining process of a plate-shaped workpiece, and a scrap skeleton present as a further machining product of the separating workpiece machining process, the product pallet comprising:
support elements formed on a machining product side for common storage of the workpiece part and the scrap skeleton in a direction of gravity,
wherein the product pallet is capable of being transferred into a first functional state and to a second functional state, wherein in the first functional state, the workpiece part and the scrap skeleton are capable of being commonly stored in the direction of gravity by the support elements, wherein in the second functional state, the product pallet forms a flat support surface on an upper side thereof, which is configured for storing only the workpiece part in the direction of gravity.

2. The product pallet according to claim 1, comprising:
an element unit provided with the support elements and a surface unit provided with the support surface, wherein the element unit and the surface unit of the product pallet are capable of being moved relative to one another in a vertical direction,
wherein in the first functional state, the element unit and the surface unit are moved relative to one another in the vertical direction into a first relative position, in which the support elements project upwards on the machining product side with respect to the support surface, and
wherein in the second functional state, the element unit and the surface unitare moved relative to one another in the vertical direction into a second relative position, in which the support elements do not project upwards on the machining product side with respect to the support surface.

3. The product pallet according to claim 2, wherein:
the element unit comprises a base on which the support elements are provided and project upwards,
the element unit is arranged with the base being below the support surface, and
the surface unit is provided on the support surface with through-openings for the support elements.

4. The product pallet according to claim 2, comprising:
a rectangular pallet frame having a first pair of frame legs and a second pair of frame legs, each of the first pair of frame legs and the second pair of frame legs comprising two mutually opposite frame legs,
wherein the first pair of frame legs is formed by the element unit, and the second pair of frame legs is formed by the surface unit.

5. The product pallet according to claim 4, wherein the frame legs of at least one of the first pair of frame legs and the second pair of frame legs are provided with a guide device for guiding the product pallet during movements in a longitudinal direction of the frame legs.

6. The product pallet according to claim 5, wherein:
the first pair of frame legs is provided with a first guide device, and the second pair of frame legs is provided with a second guide device,
in the first relative position of the element unit and the surface unit, the first guide device is available for guiding the product pallet, and in the second relative position of the element unit and the surface unit, the second guide device is available for guiding the product pallet.

7. A mechanical device for handling a workpiece part present as a machining product of a separating machining process of a plate-shaped workpiece, and a scrap skeleton present as a further machining product of the separating workpiece machining process, the mechanical device comprising a product pallet according to claim 1 for storing the workpiece part and the scrap skeleton.

8. The mechanical device according to claim 7, comprising an unloading unit for unloading the workpiece part and the scrap skeleton from the product pallet transferred into the first functional state.

9. The mechanical device according to claim 8, comprising:
a separating unit for separating the workpiece part from the scrap skeleton after being unloaded from the product pallet, and
a loading unit for loading the workpiece part separated from the scrap skeleton onto the product pallet transferred into the second functional state.

10. The mechanical device according to claim 9, wherein the separating unit forms the unloading unit for unloading the product pallet in the first functional state,
wherein the separating unit comprises a holding device, wherein the machining product stored on the product pallet in the first functional state is capable of being fixed to the separating unit via the holding device, and
wherein the machining product fixed to the holding device is capable of unloaded from the support elements of the product pallet in the first functional state.

11. The mechanical device according to claim 10, wherein the separating unit forms the loading unit for loading the product pallet in the second functional state,
wherein the separating unit with the workpiece part separated from the scrap skeleton and the product pallet in the second functional state are capable of being arranged relative to one another in such a way that the product pallet in the second functional state is arranged below the workpiece part, and
wherein the workpiece part is capable of being released from the separating unit for storing on the product pallet in the second functional state.

12. The mechanical device according to claim 11 for handling a separable product composite of the workpiece part and the scrap skeleton, wherein
the product composite is capable of being fixed to the scrap skeleton on the holding device of the separating unit, and
the separating unit comprises a vibration generator for generating vertical vibrations of the holding device, which cause the workpiece part to be released from the product composite.

13. The mechanical device according to claim 7, wherein the product pallet comprises:
an element unit provided with the support elements and a surface unit provided with the support surface, wherein the element unit and the surface unit of the product pallet are capable of being moved relative to one another in a vertical direction,
wherein in the first functional state, the element unit and the surface unit are moved relative to one another in the vertical direction into a first relative position, in which the support elements project upwards on the machining product side with respect to the support surface, and
wherein in the second functional state, the element unit and the surface unitare moved relative to one another in the vertical direction into a second relative position, in which the support elements do not project upwards on the machining product side with respect to the support surface,
the mechanical device comprising a lifting device, wherein the element unit of the product pallet and the surface unit of the product pallet are capable of being moved relative to one another in the vertical direction into the first relative position and/or into the second relative position via the lifting device.

14. The mechanical device according to claim 13, wherein
in the first relative position of the element unit and the surface unit, the surface unit is mounted on the element unit in the direction of gravity, and
in order to move the element unit and the surface unit from the first relative position into the second relative position,
the lifting device is provided for the element unit, and a support acting in the direction of gravity is provided for the surface unit, and
the element unit is capable of being lowered by the lifting device relative to the surface unit mounted on the support in the direction of gravity.

15. The mechanical device according to claim 14, wherein a stop for the element unit acting in the vertical direction in the second relative position of the element unit and the surface unit is provided on the surface unit.

16. The mechanical device according to claim 13, wherein, in order to move the element unit and the surface unit from the second relative position into the first relative position,
the lifting device is provided for the element unit, and a support acting in the direction of gravity is provided for the surface unit, and
the element unit is capable of being lifted by the lifting device relative to the surface unit mounted on the support in the direction of gravity.
